(19) United States
(12) Patent Application Publication
(10) Pub. No.: US 2015/0336009 A1
(43) Pub. Date: Nov. 26, 2015

(54) METHOD OF PROVIDING PAYMENT SERVICE BY SELECTING PAYER USING RESULT OF GAME PLAYED BY PLURALITY OF PARTICIPANTS

(71) Applicant: Young Nam KIM, Seoul (KR)

(72) Inventor: Young Nam KIM, Seoul (KR)

(21) Appl. No.: 14/820,234

(22) Filed: Aug. 6, 2015

Related U.S. Application Data
(63) Continuation of application No. PCT/KR2014/005320, filed on Jun. 17, 2014.

(30) Foreign Application Priority Data
Jun. 18, 2013 (KR) 10-2013-0070012

(51) Int. Cl. A63F 13/792

(52) U.S. Cl. CPC A63F 13/792

(57) ABSTRACT

Disclosed is a method of providing a payment service by selecting a payer using a result of a game played by a plurality of participants, a service provision server executing the game after receiving, in advance, purchase request information commonly requested by the plurality of game participants and payment information of the plurality of game participants, and performing a purchase procedure using the payment information of a participant satisfying a condition predetermined in the game when the game is finished, thereby providing an automatic payment service using a game result to users without a separate offline payment process and preventing a loser from evading his or her responsibility.

### CROSS-REFERENCE TO RELATED APPLICATION(S)

This application is a continuation application, claiming the benefit under §365(c), of an international application Ser. No. PCT/KR2014/005320, filed on Jun. 17, 2014, which claimed the benefit of a Korean patent application filed on Jun. 18, 2013 in the Korean Intellectual Property Office and assigned Serial number 10-2013-0070012, the entire disclosures of each of which is hereby incorporated by reference.

### TECHNICAL FIELD

The present invention generally relates, to a method of providing a payment service and, more particularly, to a method of providing a payment service by selecting a payer using the result of a game played by a plurality of participants.

### BACKGROUND

Traditionally, in the Republic of Korea, the traditional private funding of a private cooperative organization organized for the purpose of mutual aid, friendship, mutual benefit, financing, and the like has been widely developed so that many members of the organization can periodically contribute money, crops, clothes or the like and can take turns to receive a lump sum share of the collected contributions. In the case of farming cooperative groups, the exchanging of work, which is performed in such a manner that neighbors help out on each other's farms, and the like has been performed as a similar organization of mutual aid. Meanwhile, games, such as a ladder diagram game, played among friends or fellow workers for preparing a snack or meal expenses to promote their friendship, and the like by contributing a modest amount of money have been widely played. In these games, a plurality of participants contributes a specific benefit (money or a labor force) according to a specific rule and takes turns to receive a lump sum share of the collected contributions.

According to the recent development of computer system and information communication technologies, technologies (see Korean Patent Application No. 10-2000-0013898) for playing offline games (e.g., a ladder diagram game), that were manually played in the past, using the internet or a computer have been developed. Furthermore, a method of providing recommendation information about delivery companies while providing an internet ladder diagram game service (see Korean Patent Application No. 10-2007-0067474) have also been developed. However, in these conventional methods of providing game services using the computer, only a winner and a loser are determined, or only relevant information is provided, but a payment means is not provided. Thus, it is inconvenient in that a separate payment process should be performed offline, and it is also problematic in that no countermeasure when a loser avoids his or her responsibility according to game results.

### SUMMARY

Accordingly, the present invention has been made keeping in mind the above problems occurring in the existing methods, and an object of the present invention is to provide a method of providing a payment service by selecting a payer using the result of a game played by a plurality of participants, which is performed by a service providing server, including: executing the game after receiving, in advance, purchase request information commonly requested by the plurality of game participants and payment information of the plurality of game participants; and performing a purchase procedure using the payment information of a participant satisfying a condition predetermined in the game when the game is finished, thereby providing an automatic payment service using a game result to users without a separate offline payment process and preventing a loser from evading his or her responsibility.

In order to accomplish the above object(s), the present invention provides a method of providing a payment service by selecting a payer using the result of a game played by a plurality of participants, comprising:

(1) receiving purchase request information commonly requested by the plurality of participants transmitted from a user terminal;

(2) receiving payment information of the respective plurality of participants transmitted from the user terminal;

(3) executing a predetermined game using the user terminal; and

(4) performing a purchase procedure requested in the step (1) based on the payment information of a participant satisfying a condition predetermined in the game when the game executed in the step (3) is finished.

In the step (1), a purchase object commonly requested by the plurality of game participants may be a product or a service sold in a market affiliated with a service providing server.

Preferably, a purchase object commonly requested by the plurality of game participants in the step (1) may be at least one selected from the group including a gifticon, and a restaurant gift certificate.

Preferably, in the step (2), the payment information may be information including each card number or cellular phone number of the plurality of game participants, and each password therefor that is necessary for payment.

Preferably, the step (2) may further include (2-1) encoding the payment information received in the step (2) and temporarily storing the encoded payment information.

More preferably, the step (4) may include: (4-1) deleting the payment information of the remaining participants except for the participant satisfying the condition predetermined in the game when the game executed in the step (3) is finished; (4-2) performing a purchase procedure requested in the step (1) using the payment information of the participant satisfying the condition predetermined in the game; and (4-3) deleting the payment information of the participant satisfying the condition predetermined in the game.

Preferably, the predetermined game may be any one selected from the group including a ladder diagram game, and a draw game, and the step (3) may further include inputting information about the game participants.

Preferably, the purchase procedure of the step (4) may further include transmitting a coupon for the purchased product or service to the user terminal that is designated in advance.

Preferably, the game in the step (3) may be executed several times, and the step (4) may further include storing execution results of the game executed several times in the step (3), and determining a participant satisfying the predetermined condition by synthesizing the stored execution results of the game.

Preferably, the user terminal may be a smart device, and the steps (1) to (4) may be performed by an application program installed in the smart device.

Preferably, the purchase request information of the step (1) may include purchase request information about different kinds of multiple products having the same price.

Preferably, the game may be performed by teams composed of the plurality of game participants, and in the step (2), only payment information about representatives of each team may be transmitted.

According to a method of providing a payment service by selecting a payer using a result of a game played by a plurality of participants, a service provision server executes the game after receiving, in advance, purchase request information commonly requested by the plurality of game participants and payment information of the plurality of game participants, and performs a purchase procedure using the payment information of a participant satisfying a condition predetermined in the game when the game is finished, thereby providing an automatic payment service using a game result to users without a separate offline payment process and preventing a loser from evading his or her responsibility.

According to the present invention, offline communities beyond online digital communities performed in the past may be formed. That is, online communities may be realistically induced so that new offline communities can be formed, and a healthy and new recreation culture can be created through team play and the like.

### BRIEF DESCRIPTION OF DRAWINGS

FIG. 1 is a view illustrating the configuration of a system for realizing a method of providing a payment service by selecting a payer using the result of a game played by a plurality of participants according to an embodiment of the present invention;

FIG. 2 is a view illustrating the flow of a method of providing a payment service by selecting a payer using the result of a game played by a plurality of participants according to one embodiment of the present invention;

FIG. 3 is a view illustrating the flow of a method of providing a payment service by selecting a payer using the result of a game played by a plurality of participants according to another embodiment of the present invention;

FIG. 4 is a view illustrating a screen of a user terminal inputting purchase request information with respect to the method of providing a payment service by selecting a payer using the result of a game played by a plurality of participants according to one embodiment of the present invention;

FIG. 5 is a view illustrating a screen of the user terminal inputting payment information with respect to the method of providing a payment service by selecting a payer using the result of a game played by a plurality of participants according to one embodiment of the present invention; and

FIG. 6 is a view illustrating a screen of the user terminal executing a predetermined game with respect to the method of providing a payment service by selecting a payer using the result of a game played by a plurality of participants according to the embodiment of the present invention.

### DESCRIPTION OF THE REFERENCE NUMERALS IN THE DRAWINGS

100: Service providing server

200: User terminal

300: Affiliated market

S100: receiving purchase request information commonly requested by a plurality of participants transmitted from a user terminal

S200: receiving payment information for the respective plurality of participants transmitted from the user terminal

S210: encoding the payment information received in the step S200 and temporarily storing the encoded payment information

S300: executing a predetermined game via the user terminal

S400: performing a purchase procedure requested in the step S100 using the payment information of a payer satisfying a condition predetermined in the game when the game executed in the step S300 is finished

S410: deleting the payment information of the remaining participants except for the participant satisfying the condition predetermined in the game

S420: performing a purchase procedure requested in the step S100 using the payment information of the participant satisfying the condition predetermined in the game

S430: deleting the payment information of the participant satisfying the condition predetermined in the game

### DETAILED DESCRIPTION

Preferred embodiments of the present invention will be hereinafter described in detail with reference to the accompanying drawings in such a manner that the present invention can be easily executed by those having ordinary skill in the art. In the following description, it is to be noted that, when the functions of conventional elements and the detailed description of elements related with the present invention may make the gist of the present invention unclear, a detailed description of those elements will be omitted. Reference will now be made in greater detail to a preferred embodiment of the invention, an example of which is illustrated in the accompanying drawings. Wherever possible, the same reference numerals will be used throughout the drawings and the description to refer to the same or like parts.

Furthermore, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Also, it will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

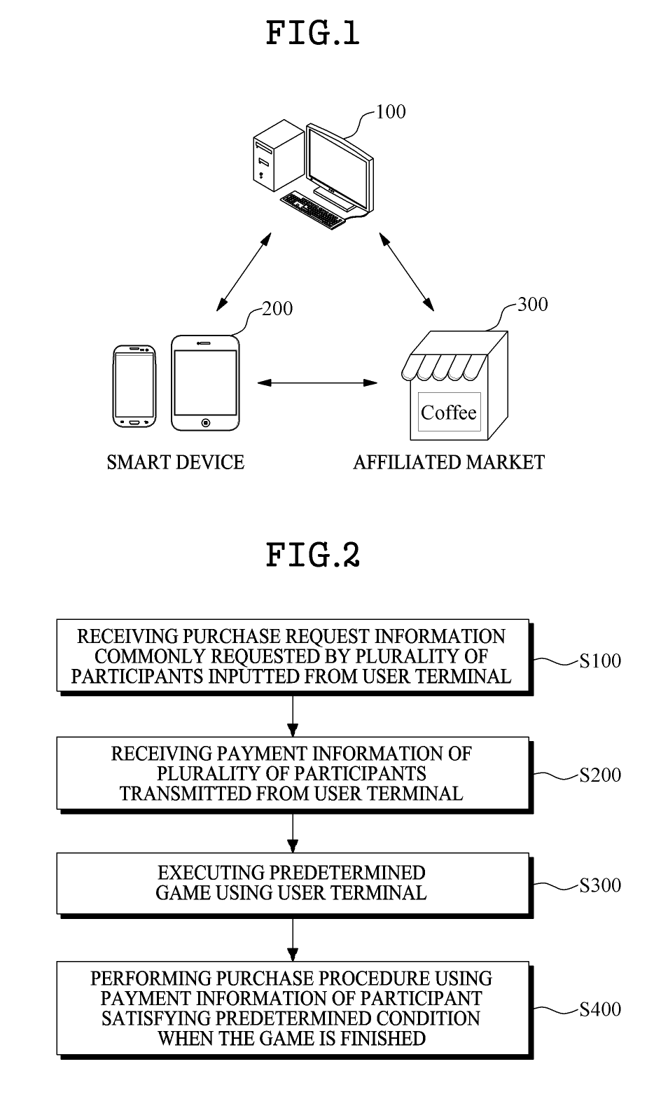

FIG. 1 is a view illustrating the configuration of a system for realizing a method of providing a payment service by selecting a payer using the result of a game played by a plurality of participants according to an embodiment of the present invention. As illustrated in FIG. 1, a system for implementing a method of providing a payment service by selecting a payer using the result of a game played by a plurality of participants according to one embodiment of the present invention may include: a service providing server 100; a user terminal 200; and an affiliated market 300.

That is, the present invention is intended to provide a payment service for a product using the result of a game. After receiving purchase request information commonly requested by the plurality of game participants and payment information of the plurality of game participants transmitted from the user terminal 200, the service providing server 100 may execute a predetermined game through the user terminal 200 and may perform a purchase procedure based on the payment information of the participants satisfying a predetermined condition when the game is finished. As such an automatic payment service using the result of the game is provided, users are not required to go through a separate payment process off-line, thereby providing convenience. Also, since the method can prevent a loser from avoiding his or her responsibility for the result of the game, a profit structure (e.g., an advertisement profit) may be created by alliance with various offline markets 300.

The service providing server 100 is a server providing a payment service for a product by selecting a payer using the result of the game played by the plurality of participants according to one embodiment of the present invention. The service providing server 100 may perform a series of process for the payment service suggested in the present invention, such as communicating with the user terminal 200 and an affiliated market 300 (a store targeted for payment).

The user terminal 200 may transmit purchase request information on products or services and the like, and payment information of the respective game participants to the service providing server 100, and may execute a predetermined game, thereby functioning to perform a purchase procedure according to the result of the game. The predetermined game may be a game installed in the user terminal 200, or a game provided by the service providing server 100. According to some embodiments, the predetermined game may be a ladder diagram game, a draw game, and the like, but is not limited thereto. The predetermined game may be executed via a screen of the user terminal 200. Furthermore, if any game can determine success and failure of the plurality of participants, or can designate (or selected and the like) some participants, all games can be applied regardless of the kind of the games. That is, if any game can derive a participant satisfying a specific condition (e.g., which may be a condition for success and failure) according to a predetermined rule, the game can be applied. This is because the participant satisfying the predetermined condition is selected as a payer.

The user terminal 200 may be various information transmission devices including a computer, a smart phone, and the like, and various means capable of communicating with the service providing server 100 may be used. In particular, since a smart device enables an on-line connection and installation of a payment application program, and does not have a place or time constraint in using it, the smart device is very appropriate to be used as the user terminal 200 in the present invention.

Meanwhile, with regard to the purchase procedure according to the present invention, various online payment methods, such micro payment using a card, a cellular phone or the like, may be used.

As a subject who sells a product or a service requested to be purchased by a user, the affiliated market 300 may transmit information on the corresponding product to the user terminal by being affiliated with the service providing server 100, and may perform a payment process therefor using the service providing server 100. The service providing server 100 may directly perform the payment process or may perform the purchase procedure in such a manner as to be connected to the payment process of the affiliated market 300.

FIG. 2 is a view illustrating the flow of a method of providing a payment service by selecting a payer using the result of a game played by a plurality of participants according to one embodiment of the present invention. As illustrated in FIG. 2, the method of providing a payment service by selecting a payer using the result of a game played by a plurality of participants according to one embodiment of the present invention, which is performed by a service providing server providing a payment service using the result of a game, may include: receiving purchase request information commonly requested by a plurality of game participants transmitted from a user terminal (S100); receiving payment information of the respective plurality of game participants transmitted from the user terminal (S200); executing a predetermined game using the user terminal (S300); and performing a purchase procedure requested in the step S100 using the payment information of a game participant satisfying a condition predetermined in the game when the game executed in the step S300 is finished (S400).

In the step S100, the service providing server may receive the purchase request information commonly requested by the plurality of game participants transmitted from the user terminal 200. An object targeted for purchase commonly requested by the plurality of game participants may be a product or a service sold in the service providing server 100 and the affiliated market 300. Preferably, the object targeted for purchase may be at least one selected from the group including a gifticon, a restaurant gift certificate, and the like. Gifticon means an online present coupon in a barcode form that can be transmitted as a text message via a cellular phone, and enables purchasing of a product with prepayment via a cellular phone, and thereafter, a recipient can change the gifticon into a real product in a store by using only the barcode. In the case of such a gifticon, since a payment process therefor has been already established, it is suitable for utilization in the present invention. However, the purchase object is not limited thereto, and may be various coupons that can be purchased in advance and can be then exchanged into products or services. These coupons may be transmitted in the form of a serial number, an image, a bar-code, a QR code, or the like to the user terminal 200. Also, the purchase request information may include information about a plurality of products, wherein the products may be different kinds of products. According to one embodiment, the purchase request information may include purchase request information about different kinds of multiple products having the same price (e.g., café latte, caramel macchiato, and the like).

In the step S200, the service providing server may receive the payment information of the respective plurality of game participants transmitted from the user terminal 200. The payment information may be information including each card number or cellular phone number of the plurality of game participants, and each secret number therefor that is necessary for payment. The game played in the present embodiment of the invention may be performed in such a manner that the plurality of game participants individually participate in the game. In such a case, the payment information received to the service providing server in step S200 may be payment information of each individual who individually participates in the game. However, according to another embodiment, the game may be performed by teams. In such a case, in the step S200, only payment information about representatives of each team may be transmitted. That is, the game is performed in such a manner that the plurality of game participants constitutes teams, and in the step S200, only payment information about the representatives of each team may be transmitted.

In the step S300, a predetermined game may be executed using the user terminal 200. Preferably, the predetermined game may be one selected from the group including a ladder diagram game, a draw game, and the like. The step S300 may further include receiving the information on game participants necessary for the ladder diagram game and the draw game.

In the step S400, when the game executed in the step S300 is finished, the purchase procedure requested in step S100 may be performed using the payment information of a participant satisfying a condition predetermined in the game. The purchase procedure may be performed according to a prepared payment process of the service providing server 100, a server provided in the affiliated market 300, or the like by inputting a card number or a cellular phone number, and a password therefor (or a verification code). After the payment process has been performed, the service providing server 100 may transmit a coupon for the purchased product or service to the user terminal.

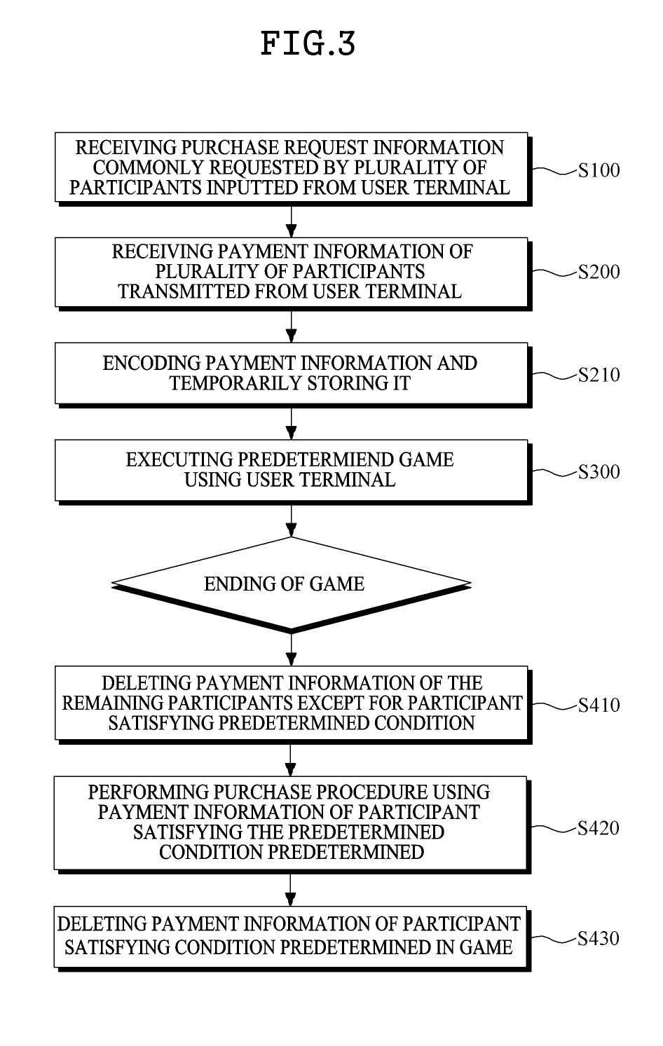

FIG. 3 is a view illustrating the flow of a method of providing a payment service by selecting a payer using the result of a game played by a plurality of participants according to another embodiment of the present invention. As illustrated in FIG. 3, the method of providing a payment service by selecting a payer using the result of a game played by a plurality of participants according to the other embodiment of the present invention may further include: encoding the payment information received in the step S200 and temporarily storing the encoded payment information (S210) after the step S200, so that a security problem of personal payment information can be settled. Also, the step S400 may include: automatically deleting the payment information of the remaining participants except for the participant satisfying the condition predetermined in the game (S410); performing a purchase procedure requested in the step S100 using the payment information of the participant satisfying the condition predetermined in the game (S420); and deleting the payment information of the participant satisfying the condition predetermined in the game (S430). That is, even though the payment information is encoded and stored, the payment information is stored in a temporary storage only during the game not to be placed on record and is deleted immediately when the game is finished, so that personal information (payment information, a card number, a cellular phone number, a password, and the like) can be prevented from being leaked.

According to some embodiments, by limiting a total of purchasing cost upon transmitting the purchase request information, a subsequent procedure does not proceed when an amount of money beyond a predetermined amount of money is inputted, so that excessive payment can be prevented, and damage generated due to the surreptitious use of personal information can be minimized.

Also, with regard to the method of providing the payment service of a product by selecting a payer using the result of a game played by a plurality of participants according to one embodiment of the present invention, in the step S300, the game may be executed several times, and the step S400 may further include storing results of the game executed several times in the step S300, and determining a participant satisfying a predetermined condition by synthesizing the stored execution results of the game. That is, like 2 wins of three games or a tournament method, a game may be executed several times. In such a case, information about execution results of each game (a win, a loss, or the like) is temporarily stored in a memory of the service providing server 100, and a final payer is selected by synthesizing the stored information about the execution results of each game after all games have been finished.

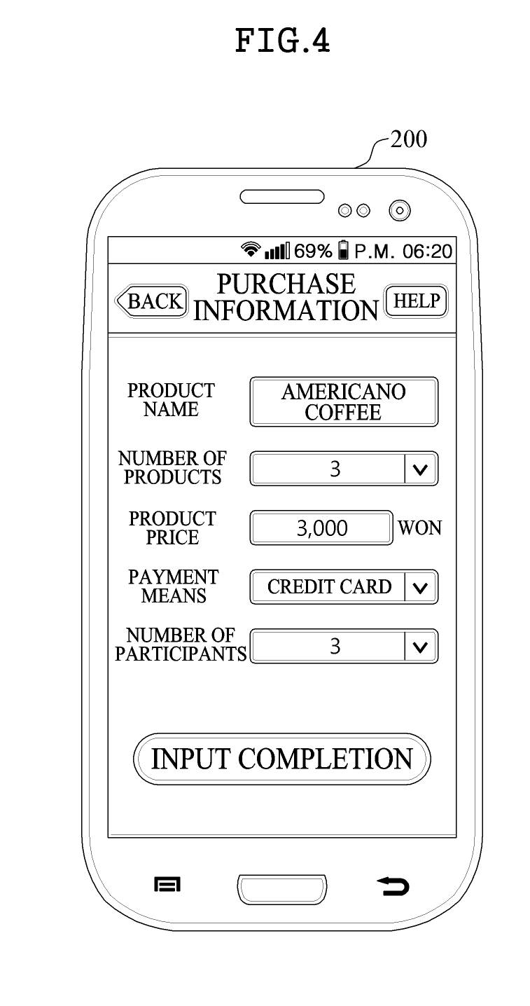

Meanwhile, the method of providing the payment service of a product by selecting a payer using the result of a game played by a plurality of participants, suggested in the present invention, may be performed by a smart device. That is, in the present invention, the user terminal 200 may be a smart device, and the steps S100 to S400 may be performed by the application program installed in the smart device. A process of the method of providing a payment service, which is performed by the application program installed in the smart device, will be described with reference to FIGS. 4 to 6.

FIG. 4 is a view illustrating a screen of a user terminal for inputting purchase request information with respect to the method of providing a payment service by selecting a payer using the result of a game played by a plurality of participants according to one embodiment of the present invention. As illustrated in FIG. 4, the user may input purchase request information including a product name (e.g., Americano coffee) to be purchased by the user, the number of products (e.g., three products), a product price (e.g., 3,000 won), a payment means (e.g., a credit card), and the like via an application program installed in a smart device. The service providing server 100 may receive the purchase request information by communication with the smart device 200. Also, the service providing server may receive, in advance, information about the number of participants (e.g., three participants) who will participate to the game performed in the subsequent step S300.

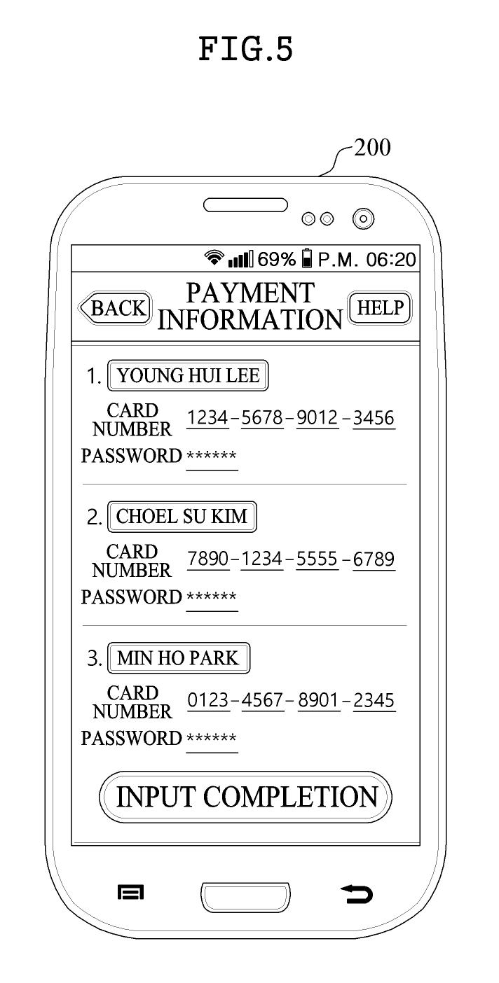

FIG. 5 is a view illustrating a screen of the user terminal inputting payment information with respect to the method of providing a payment service by selecting a payer using the result of a game played by a plurality of participants according to one embodiment of the present invention. As illustrated in FIG. 5, the user may input payment information (e.g., names, card numbers, passwords, and the like) of all participants of the game played in the step S300, which is a subsequent step, using the application program installed in the smart device. The service providing server 100 may receive the payment information by communication with the smart device 200.

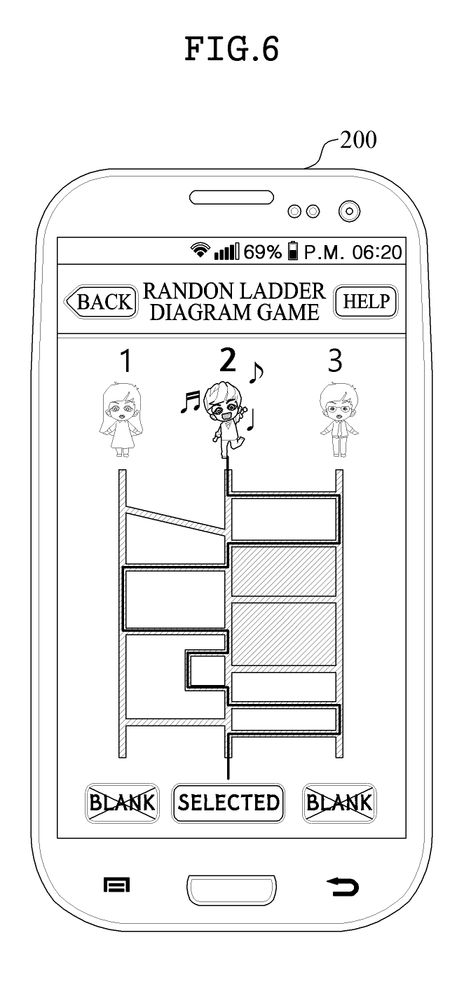

FIG. 6 is a view illustrating a screen of the user terminal executing a predetermined game with respect to the method of providing a payment service by selecting a payer using the result of a game played by a plurality of participants according to the embodiment of the present invention. As illustrated in FIG. 6, when transmission of the payment information is completed, the service providing server 100 may transmit a game starting signal so that a ladder diagram game can be played via the application program installed in the smart device 200. The user performs the ladder diagram game via the application program installed in the smart device, and an execution result of the ladder diagram game (information about a participant satisfying the predetermined condition (selected as a payer) is immediately transmitted to the service providing server 100.

Immediately when receiving information about a selected payer (e.g., Su Cheol Kim of No. 2), the service providing server 100 may automatically delete the temporarily stored payment information of the remaining participants except for the selected payer and may immediately perform the purchase procedure using the payment information of the selected payer.

In the present invention, the service providing server for payment may enable a game to be played by communication with the user terminal 200 and a payer to be selected using the result of the game, thereby immediately performing a procedure for purchasing a product or a service. Thanks to such a configuration, payment convenience can be provided to users, a loser (selected as a payer) can be prevented from avoiding his or her responsibility, and interests in the game can be doubled. Also, a new benefit creation structure may be formed through a relationship with the affiliated market 300.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a payment service by selecting a payer using a result of a game played by a plurality of game participants, which is performed by a service providing server providing the payment service using the result of the game, comprising: (1) receiving purchase request information commonly requested by the plurality of game participants transmitted from a user terminal; (2) receiving payment information of the respective plurality of participants transmitted from the user terminal; (3) executing a predetermined game using the user terminal; and (4) performing a purchase procedure requested in the step (1) based on the payment information of a game participant satisfying a condition predetermined in the game when the game executed in the step (3) is finished.

2. The method of claim 1, wherein a purchase object commonly requested by the plurality of game participants in the step (1) is a product or a service sold in a market affiliated with the service providing server.

3. The method of claim 1, wherein a purchase object commonly requested by the plurality of game participants in the step (1) is at least one selected from the group including a gifticon, and a restaurant gift certificate.

4. The method of claim 1, wherein, in the step (2), the payment information is information including each card number or cellular phone number of the plurality of game participants, and each password therefor that is necessary for payment.

5. The method of claim 1, wherein the step (2) further comprises (2-1) encoding the payment information received in the step (2) and temporarily storing the encoded payment information.

6. The method of claim 5, wherein the step (4) comprises:
(4-1) deleting the payment information of the remaining participants except for the participant satisfying the condition predetermined in the game when the game executed in the step (3) is finished;
(4-2) performing a purchase procedure requested in the step (1) using the payment information of the participant satisfying the condition predetermined in the game; and
(4-3) deleting the payment information of the participant satisfying the condition predetermined in the game.

7. The method of claim 1, wherein the purchase procedure of the step (4) further comprises transmitting a coupon for the purchased product or service to the user terminal that is designated in advance.

8. The method of claim 1, wherein the predetermined game is any one selected from the group including a ladder diagram game and a draw game, and the step (3) further comprises inputting information about the game participants.

9. The method of claim 1, wherein the game in the step (3) is executed several times, and the step (4) further comprises storing execution results of the game executed several times in the step (3), and determining a participant satisfying the predetermined condition by synthesizing the stored execution results of the game.

10. The method of claim 1, wherein the user terminal is a smart device, and the steps (1) to (4) are performed by an application program installed in the smart device.

11. The method of claim 1, wherein the purchase request information of the step (1) comprises purchase request information about different kinds of multiple products having the same price.

12. The method of claim 1, wherein the game is performed by teams composed of the plurality of game participants, and in the step (2), only payment information about representatives of each team is transmitted.
